(19) United States
(12) Patent Application Publication
(10) Pub. No.: US 2001/0004091 A1
(43) Pub. Date: Jun. 21, 2001

(54) Portable automatic misting device

(76) Inventors: Gary Wintering, Tempe, AZ (US); Leonard Montenegro, Tempe, AZ (US)

Correspondence Address: Jordan M. Meschkow, MESCHKOW & GRESHAM, P.L.C., Suite 409, 5727 North Seventh Street, Phoenix, AZ, 85014, US

(21) Appl. No.: 09/774,828

(22) Filed: Jan. 17, 2001

Related U.S. Application Data
(63) Continuation-in-part of application No. 09/444,910, filed on Nov. 22, 1999.
Application No. 09/444,910 is a continuation-in-part of application No. 08/947,228, filed on Oct. 8, 1997, now Pat. No. 6,095,434.

(51) Int. Cl. B05B 9/04

(52) U.S. Cl. 239/333; 239/321; 239/373; 222/385; 222/386

(57) ABSTRACT

A portable automatic misting device (20) uses a misting device assembly (38) to automatically disperse a mist (36). The misting assembly (38) includes a hollow cylinder (40) that forms a liquid reservoir (50) that is in fluid communication with a one-way valve (128) that permits liquid flow into the reservoir (50) from a liquid container (118). The reservoir (50) has fluid communication with a misting nozzle (34) through a hollow plunger rod (28). A plunger (42), a spring (48) and a portion of the plunger rod (28) are located inside the hollow cylinder (40). The spring (48) is biased to move the plunger (42) and the plunger rod (28) to automatically shrink the liquid reservoir (50). A second one-way valve (122) permits a passage of air into the liquid container (118) to equalize pressure therein.

### RELATED INVENTION

The present invention is a continuation in part (CIP) of “Portable Automatic Misting Device,” U.S. patent application Ser. No. 09/444,910, filed Oct. 22, 1999, which is a continuation in part of “Portable Automatic Misting Device,” U.S. patent application Ser. No. 08/947,228, filed Oct. 8, 1997, now U.S. Pat. No. 6,095,434, each of which is incorporated by reference herein.

### TECHNICAL FIELD OF THE INVENTION

The present invention relates generally to the field of atomization of liquids. More specifically, the present invention pertains to a portable device for automatic mist generation.

### BACKGROUND OF THE INVENTION

The use of misting devices to produce a cooling effect in a relatively high temperature environment is well known. The cooling effect is produced by an evaporation and absorption of an atomized or vaporized liquid (usually water) by a surrounding high temperature gas (usually air). This evaporation and absorption process reduces the air temperature in an area proximate to the mist. Atomizing or misting nozzles connected to a pressurized water supply are commonly used to produce this cooling mist or vapor.

A known application of this principal attaches multiple misting nozzles to a length of hollow pipe. The pipe is closed at one end and is attached to a pressurized water supply at another end. The pipe is attached to a fixed surface or support such as a post or several ceiling joists. This provides a cooling mist for a local area covered by the fixed misting system.

Other applications use portable or personal misting devices that can be easily carried by individuals wherever they go and activated whenever the individuals choose. One such device incorporates an air pumping mechanism with a portable water bottle and a valve actuated misting nozzle. The air pumping mechanism uses a single cup seal attached to an end of a hollow plunger rod residing inside a hollow cylinder, to force air inside the hollow cylinder into the water bottle. For this device, the hollow cylinder is located inside the water bottle and has passages, seals, and one-way valves that allow unidirectional flow from the cylinder into the water bottle. By sliding the plunger rod back and forth inside the hollow cylinder, air is taken in through a one-way valve in the hollow plunger rod, and passed into the hollow cylinder where the cup seal forces the air through another one-way valve and into the water bottle. A valve-actuated misting nozzle is attached to the top of the water bottle such that when the water bottle has a sufficient amount of water and compressed air, pressing or holding the valve down causes water to be dispersed through the misting nozzle.

Unfortunately, this portable misting device requires excessive repetitive pumping action to provide sufficient air pressure inside the water bottle before misting can take place. The number of pumps determines the amount of air pressure inside the water bottle, which determines the duration and pressure of the mist available to the individual. Longer lasting, higher-pressure mist is desirable for cooling purposes. Unfortunately, to achieve a desirably longer lasting higher-pressure mist, the individual needs to perform more and more pump strokes to increase the air pressure in the water bottle. Furthermore, the valve actuating the misting nozzle must be held depressed during the misting operation, resulting in an inconvenient hands-on type of operation. This misting device uses compressed air to force water through the misting nozzle which requires seals and valves that can provide not only watertight but airtight connections as well.

Another problem exists in that the container configured to contain the liquid to be rendered into the mist must be vented to allow pressure equalization therein. Such vented containers typically leak if not properly positioned. This is corrected by maintaining such containers in a requisite “upright” position, thereby undesirably limiting the use and functionality of such containers.

Containers may be sealed to eliminate leaking. Such a sealed container would typically be manually unsealed for pressure equalization. This adds to the operational complexity and is therefore undesirable.

Accordingly, a need exists for a portable automatic misting device that can pressurize and automatically disperse a liquid through a misting nozzle for a desirable length of time. Such a device should also provide for ease of portability and operation.

A need also exists for a non-leaking liquid container that may be used in any orientation and that automatically performs pressure equalization.

### SUMMARY OF THE INVENTION

Accordingly, it is an advantage of the present invention to provide a portable automatic misting device.

Another advantage of the present invention is to provide a portable automatic misting device that is actuated by a single manual input-pumping stroke.

Another advantage of the present invention is to provide a portable automatic misting device that is easy to carry and easy to operate.

Another advantage of the present invention is to provide a portable automatic misting device that generates a relatively high hydraulic pressure to produce the mist.

Another advantage of the present invention is to provide a portable automatic misting device that does not use airtight seals.

Another advantage of the present invention is that a liquid container is provided that may be used in any orientation.

Another advantage of the present invention is that a liquid container is provided that automatically equalizes pressure within the container.

The above and other advantages of the present invention are carried out in one form by a portable automatic misting device that uses a misting device assembly to automatically disperse a mist. The misting device incorporates a liquid container having a substantially self-closing one-way valve coupled thereto to permit the passage of air to equalize pressure within the liquid container. A hollow cylinder is located within the liquid coupled to form a liquid reservoir therein. A plunger is located within the hollow cylinder. The plunger is configured to form a substantially liquid-tight seal with an inner circumference of the cylinder to form the reservoir. A plunger rod has a first end affixed to the plunger proximate the reservoir and a second end opposing the first end and affixed to a handle. A second one-way valve is coupled to the cylinder and configured to permit liquid flow into the reservoir. A resilient member is coupled to the plunger and biased to automatically shrink the reservoir. A misting nozzle is fluidly coupled to the cylinder through the handle, the plunger rod, and the plunger.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 shows a perspective view of a preferred embodiment of a portable automatic misting device;

FIG. 2 shows a perspective and cut-away view of an exemplary portable automatic misting device assembly;

FIG. 3 shows an exploded perspective view of the portable automatic misting device assembly;

FIG. 4 shows a perspective view of an exemplary one-way flapper valve;

FIG. 5 shows an exploded perspective view of an exemplary misting nozzle, plunger rod and handle used by the portable automatic misting device assembly;

FIG. 6 shows a cross-sectional side view of a plunger and plunger rod coupling used by the portable automatic misting device assembly;

FIG. 7 shows a perspective view of a preferred embodiment of a portable automatic misting device having a remotely located liquid supply container;

FIG. 8 shows a perspective view of an alternative embodiment of a portable automatic misting device assembly utilizing dual one-way valves;

FIG. 9 shows a cross-sectional view of a portion of the portable automatic misting device assembly of FIG. 8;

FIG. 10 shows a cutaway view of a portable automatic misting device utilizing the assembly of FIG. 8 within a liquid container;

FIG. 11 shows perspective view of a portable automatic misting device utilizing the assembly of FIG. 8 with a remotely located liquid supply container;

FIG. 12 shows a perspective view of an alternative embodiment of a portable automatic misting device utilizing a sealed self-equalizing liquid container; and

FIG. 13 shows a cross-sectional view of the portable automatic misting device of FIG. 12.

### DETAILED DESCRIPTION OF THE PREFERRED EMBODIMENTS

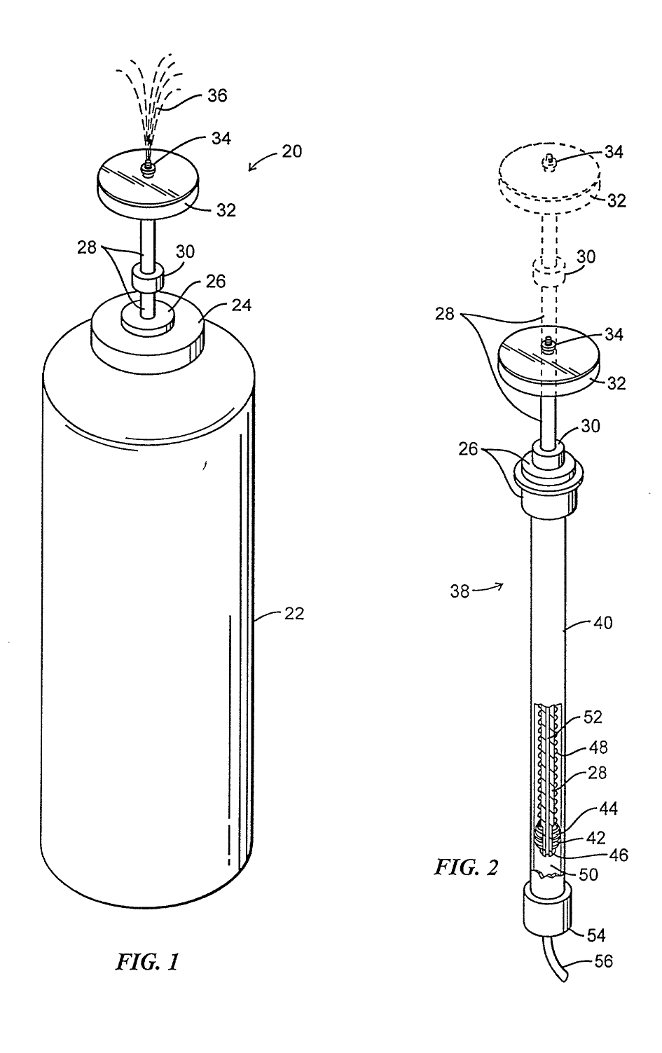

FIG. 1 shows a diagram of a preferred embodiment of a portable automatic misting device 20 having a liquid container 22 with a removable coupling 24 surrounding an exit collar 26. A length of hollow plunger rod 28 extends through exit collar 26 and a plunger rod retaining collar 30 and attaches to handle 32. A misting nozzle 34 is attached to handle 32 and is capable of dispersing a mist 36.

FIG. 2 shows a perspective, cut-away view of an exemplary portable automatic misting device assembly 38. For one preferred embodiment, misting device 20 (FIG. 1) is made up of misting device assembly 38 and liquid container 22, with a portion of assembly 38 located inside liquid container 22 (see FIG. 1). A cut-away portion of assembly 38 in FIG. 2 reveals a hollow cylinder 40 containing a plunger 42 that is coupled to and surrounds a portion of hollow plunger rod 28. Plunger 42 is restrained between a plunger-rod collar 44 attached to plunger rod 28 and a threaded coupling 46. A compression spring 48 is shown coaxially mounted around plunger rod 28, and is restrained by plunger-rod collar 44 and exit collar 26. Hollow cylinder 40 is shown forming a liquid reservoir 50 that has fluid communication with misting nozzle 34 through a centrally located flow passage 52 formed by the inside of hollow plunger rod 28. Hollow cylinder 40 also has an inlet collar 54 that is coupled to an inlet hose 56.

FIG. 2 additionally shows in phantom a second position of handle 32 and plunger rod 28. Solid lines in FIG. 2 show spring 48 being extended to a relatively relaxed state such that reservoir 50 has a minimum size. When handle 32 is moved to the phantom position, spring 48 is compressed to a relatively unrelaxed state such that reservoir 50 has a larger than minimum size (not shown).

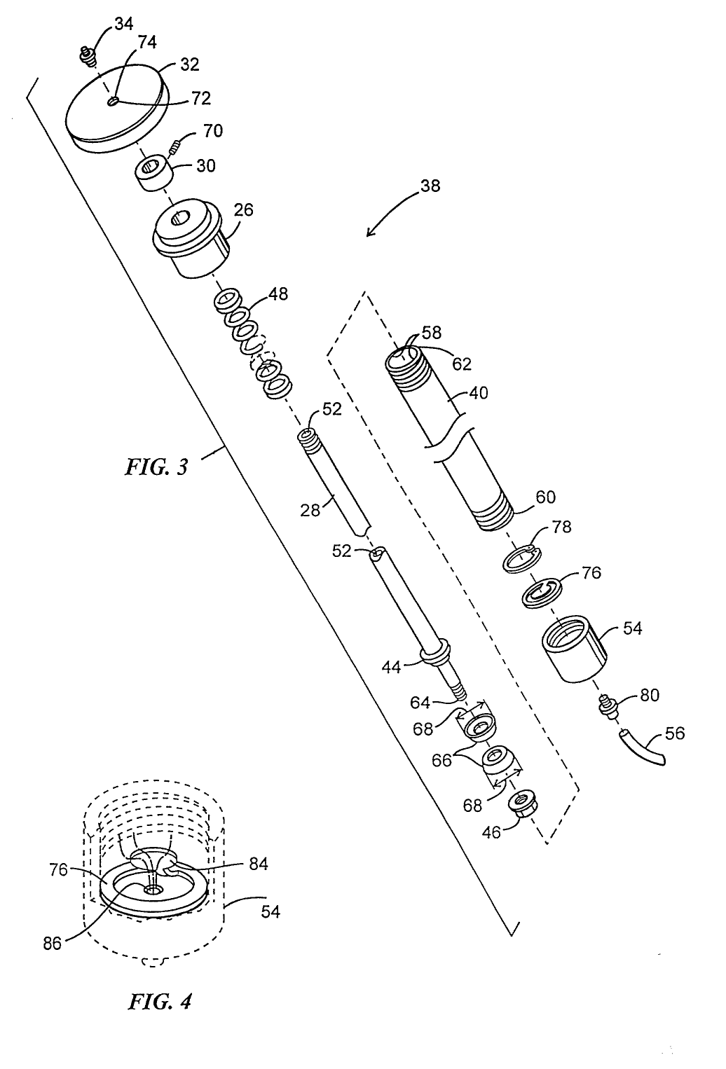

FIG. 3 shows an exploded perspective view of portable automatic misting device assembly 38. Hollow cylinder 40 is shown having an inner circumference 58, an inlet end 60, and an exit end 62. Inlet end 60 is located proximate reservoir 50 (FIG. 2), as is a reservoir end 64 of plunger rod 28. Plunger rod collar 44 is located or attached at a distance from reservoir end 64 such that when assembled, washers 66 surround a portion of plunger rod 28 and are restrained by collar 44 and threaded coupling 46. Washers 66 are exemplary cup-seal-shaped washers, each having a larger side 68 (i.e., a side having a larger diameter). Larger side 68 of washers 66 contact collar 44 or threaded coupling 46 when coupled to form plunger 42 (FIG. 2). Compression spring 48 is a resilient member that is coaxially positioned around plunger rod 28. Retainer collar 30 has a set screw 70 that, when tightened, couples retainer collar 30 to plunger rod 28 at a desired position to define the minimal size of reservoir 50 (FIG. 2). Handle 32 has an exit orifice 72 and a flow passage 74 connecting flow passage 52 of plunger rod 28 with exit orifice 72 of handle 32. A one-way flapper valve 76 is positioned inside inlet collar 54 by a valve retainer 78. Also shown is an inlet fitting 80 that couples to inlet collar 54 and to inlet hose 56.

FIG. 4 shows a perspective view of an exemplary one-way flapper valve 76 positioned inside inlet collar 54. Flapper valve 76 is shown having a flap 84 in an open position, so as to permit liquid flow through an inlet orifice 86 into reservoir 50 (FIG. 2). Those skilled in the art realize that a ball valve or any of a variety of one-way valves could be used to regulate liquid flow into reservoir 50 (FIG. 2).

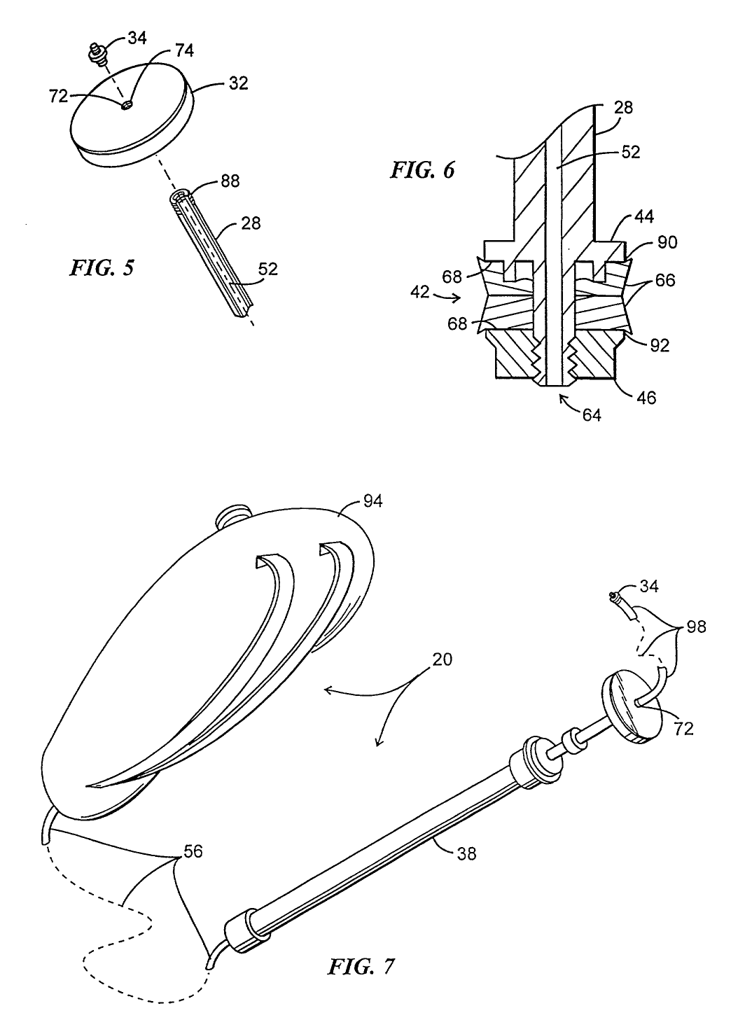

FIG. 5 shows an exploded perspective view of exemplary misting nozzle 34, hollow plunger rod 28 and handle 32. Plunger rod 28 is attached to handle 32 by a threaded coupling 88 and is configured to align plunger rod flow passage 52, with handle flow passage 74 and exit orifice 72.

FIG. 6 shows a cross-sectional side view of the mutual coupling between plunger 42 and plunger rod 28. Plunger 42 is coupled proximate plunger rod reservoir end 64 and is formed by coupling washers 66 together. Each washer 66 has a trapezoidal cross-section such that larger side 68 of one washer 66 overlaps a plunger rod collar outer diameter 90 and larger side 68 of second washer 66 overlaps an outer diameter 92 of threaded coupling 46. This overlapping washer material contacts hollow cylinder inner circumference 58 (FIG. 3) and forms a reliable watertight seal where contact is made.

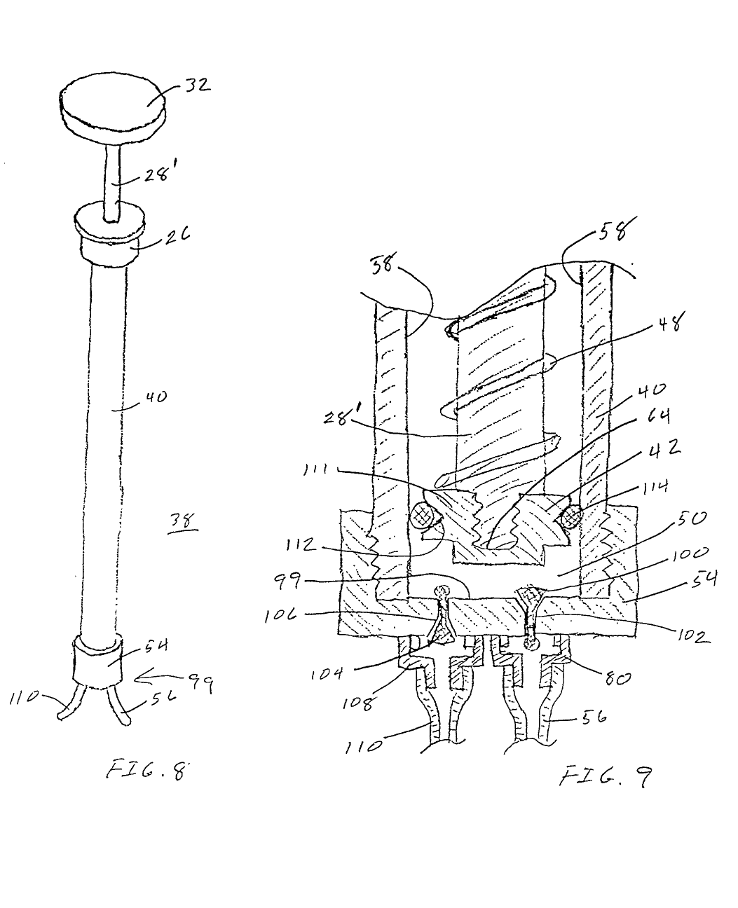

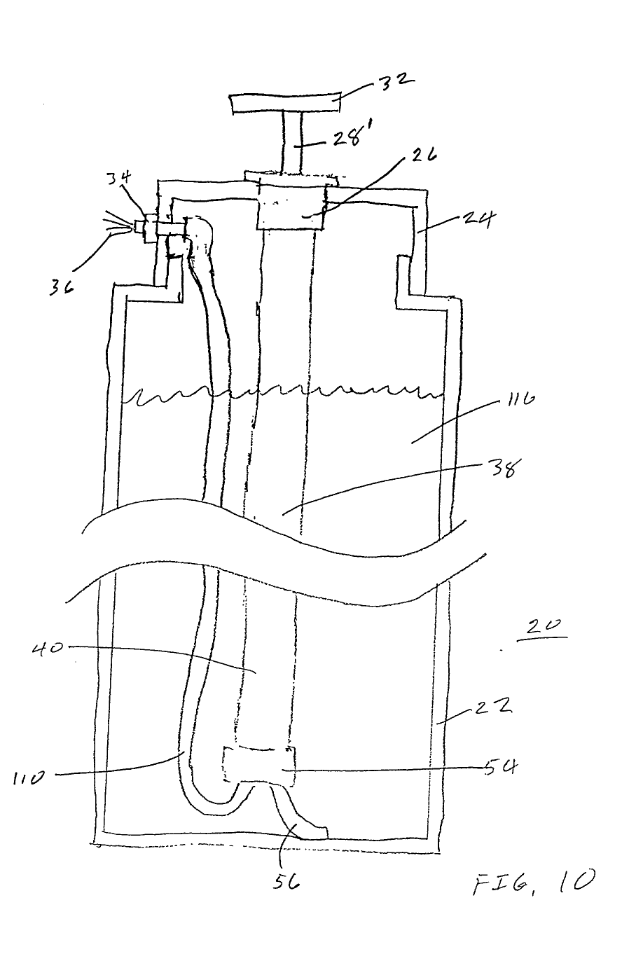

FIG. 7 shows a diagram of a preferred embodiment of portable automatic misting device 20. In this embodiment, misting device assembly 38 is coupled to a remotely located liquid supply container 94 by inlet hose 56. Separating misting device assembly 38 from liquid supply container 94 provides an ergonomic method for conveniently transporting or carrying relatively large amounts of liquid for providing a relatively high quantity of desirable misting operations. Inlet hose 56 provides a fluid connection between supply container 94 and one-way valve 76 (FIG. 4). In this embodiment, an exit hose 98 couples between exit orifice 72 and misting nozzle 34, allowing misting nozzle 34 to be directed independently from misting device assembly 38.

In operation, misting device 20 is activated or charged by retracting or pulling up on handle 32 to a relative position (phantom in FIG. 2). In this position, spring 48 is compressed and biased to automatically shrink reservoir 50 when it is released. Flapper valve 76 is open and flap 84 is positioned to permit liquid flow through inlet orifice 86 (FIG. 4). Cup-seal-shaped washers 66 of plunger 42 form a liquid-tight seal with hollow cylinder inner circumference 58 (FIG. 3). Releasing handle 32 causes plunger 42 and plunger rod 28 to move towards inlet end 60. This movement creates hydraulic pressure that causes flapper valve 76 to close, positioning flap 84 over inlet orifice 86, preventing liquid flow through orifice 86 (FIG. 4, valve 76 shown open). Moreover, releasing handle 32 shrinks reservoir 50 (FIG. 2) and forces a displaced quantity of liquid from reservoir 50 into flow passage 52 (FIGS. 2 and 3). This displaced fluid in flow passage 52 is forced by hydraulic pressure through handle flow passage 74, exit orifice 72 and misting nozzle 34 (FIG. 5), producing mist 36 (FIG. 1).

For the above embodiments, spring 48 is a compression or coil spring. However, those skilled in the art will realize that a leaf spring or any of a variety of springs or resilient members could be used to regulate the size of reservoir 50. Moreover, plunger 42 is formed by coupling two cup-seal-shaped washers 66 together to provide a high-pressure seal for the bidirectional operation of plunger rod 28. This dual-cup-seal configuration provides delivery of a higher-pressure liquid to misting nozzle 34 than is achieved by conventional single-seal configurations.

For one preferred embodiment, liquid container 22 is configured to surround misting device assembly 38 and provide an easily portable and refillable liquid supply for misting operation (FIG. 1). In this embodiment, misting device 20 can be conveniently placed on a flat surface. Handle 32 may then be extended (FIG. 2 phantom position) and released. A one-stroke operation that provides a hands-off automatic mist dispersion for a desirable length of time (see FIG. 1) results.

In another embodiment, remotely located liquid supply container 94 (FIG. 7) provides fluid to assembly 38 through inlet hose 56.

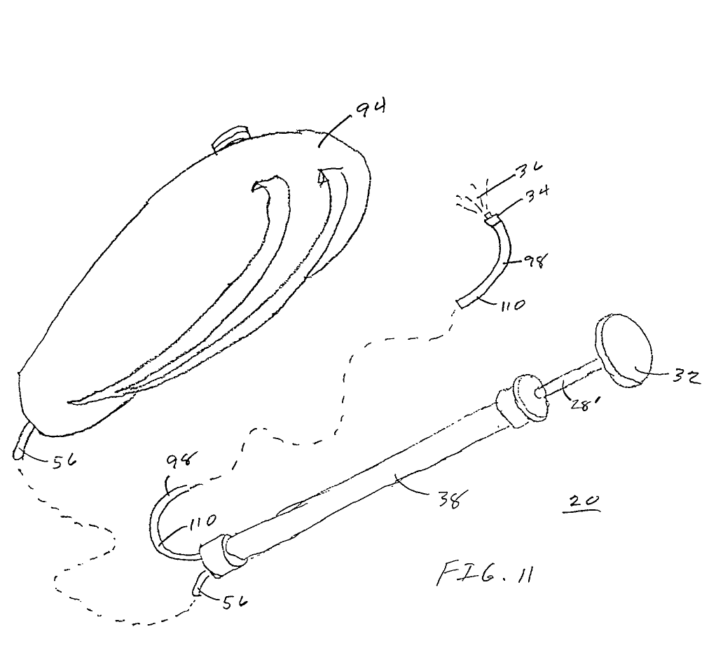

In an alternative preferred embodiment of FIGS. 8 and 9, portable automatic misting device assembly 38 may be realized as a single-ended assembly using dual one-way valves. In this embodiment, hollow cylinder 40 is “single-ended,” i.e., the fluid enters and exits the same end of cylinder 40, a reservoir end 99.

During the pumping stroke, i.e., when handle 32 is pulled, plunger rod 28′ draws plunger 42 upward, increasing the size of reservoir 50. This in turn unseats a conical inlet plug 100 in a one-way inlet plug valve 102 and substantially simultaneously seats a conical outlet plug 104 in a one-way outlet plug valve 106. This allows fluid to be drawn through inlet hose 56, through inlet fitting 80, through inlet one-way plug valve 102, and into reservoir 50. This handle-pulling action compresses compression spring 48.

When handle 32 is released, compression spring 48 pushes against plunger 42 to decrease the size of reservoir 50. This in turn seats conical inlet plug 100 in inlet one-way plug valve 102 and substantially simultaneously unseats conical outlet plug 104 in outlet one-way plug valve 106. This allows fluid to be passed from reservoir 50, through outlet one-way plug valve 106, through an outlet fitting 108, and through an outlet hose 110.

Those skilled in the art will appreciate that while inlet and outlet valves 102 and 106 are one-way plug valves, other one-way valves may be used, e.g., flapper valves, without departing from the spirit of the present invention.

As in the previously discussed embodiments, handle 32, plunger rod 28′, and plunger 42 are affixed together to regulate the size of reservoir 50. Unlike the previously discussed embodiments, however, the fluid does not pass through plunger 42 and plunger rod 28′ in this single-ended, dual-valve embodiment. Therefore, plunger rod 28′ and plunger 42 may be solid, as depicted in FIG. 9.

In the hereinbefore discussion, plunger 42 included plunger rod collar 44, first and second cup seal washers 66, and threaded coupling 46 (see FIGS. 3 and 6). The outer circumferences of washers 66 were configured to form a substantially watertight seal with inner circumference 58 of hollow cylinder 40.

FIG. 9 depicts an alternative embodiment of plunger 42. In this alternative embodiment, plunger 42 has a body 111 with a circumferential groove 112 in which resides an O-ring 114. Plunger body 111 is affixed to reservoir end 64 of plunger rod 28′ by being threaded thereon. O-ring 114 contacts inner circumference 58 of hollow cylinder 40 to form the requisite substantially watertight seal. Those skilled in the art will appreciate that the embodiments described herein for plunger 42 are effectively interchangeable. Those skilled in the art will also appreciate that plunger body 111 may be affixed to plunger rod 28′ by methods other than being threaded thereupon without departing from the spirit of the present invention.

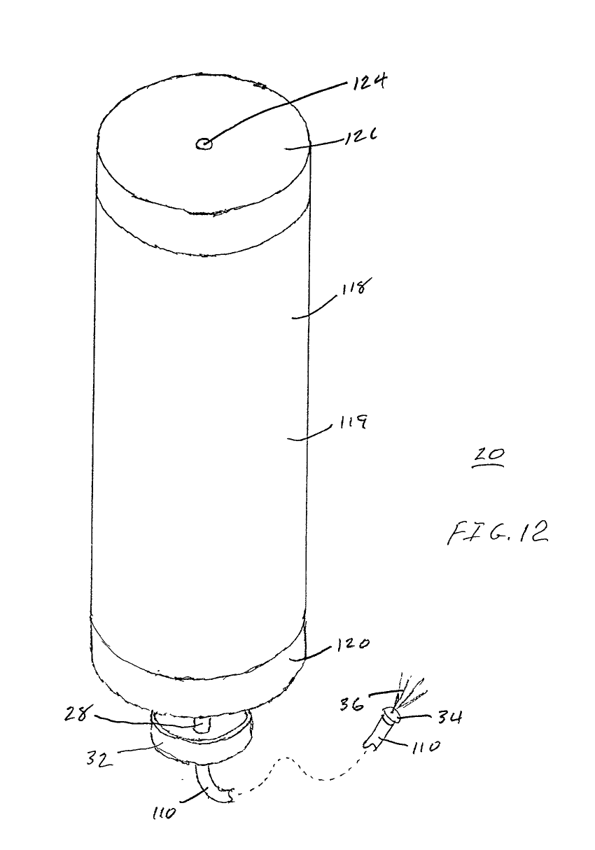

FIG. 10 shows portable automatic misting device 20 utilizing the single-ended, dual-valve embodiment of misting device assembly 38 with enclosing liquid container 22. In this embodiment, outlet hose 110 is connected to misting nozzle 34, which is attached to and passes through removable coupling 24 (i.e., a cap of container 22). Container 22 is filled with a fluid 116, which passes into inlet hose 56, through misting device assembly 38, through outlet hose 110, and through misting nozzle 34 to produce mist 36.

FIG. 11 shows portable automatic misting device 20 utilizing the single-ended, dual-valve embodiment of misting device assembly 38 with remotely located liquid supply container 94. In this embodiment, outlet hose 110 is coincident with exit hose 98 (also see FIG. 7). Fluid (not shown) passes from remotely located liquid supply container 94, through inlet hose 56, through misting device assembly 38, through outlet/exit hose 110/98, and through misting nozzle 34 to produce mist 36. This embodiment has several distinct advantages in that both container 94 and misting nozzle 34 are separated from device assembly 38, hence isolated from any motion imparted to device assembly 38 during the pumping stroke, i.e., the action of drawing handle 32.

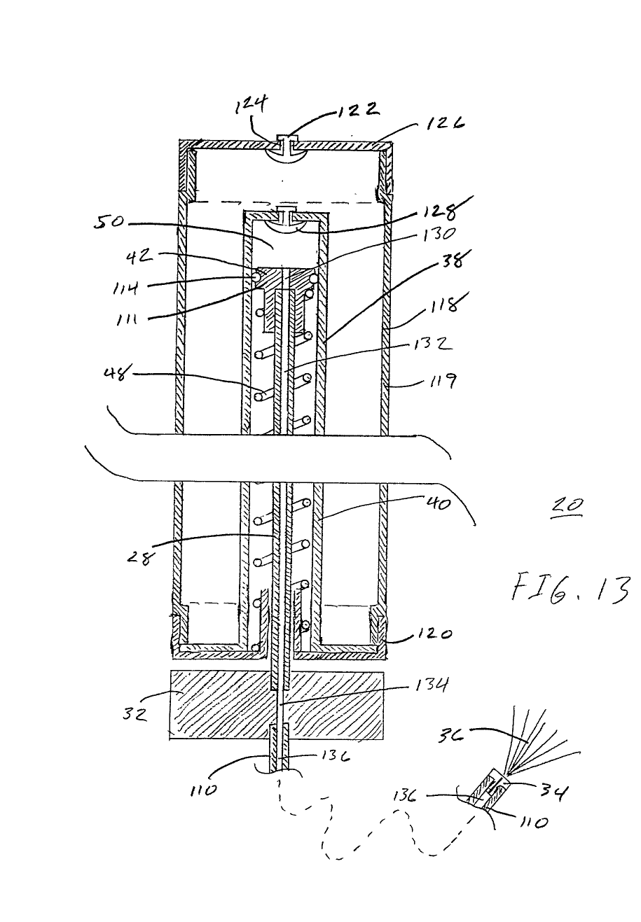

FIGS. 12 and 13 show perspective and cross-sectional views, respectively, of an alternative embodiment of portable automatic misting device 20 utilizing a substantially sealed self-equalizing liquid container 118. The following discussion refers to FIGS. 12 and 13.

Liquid container 118 differs from liquid container 22 of other embodiments discussed hereinbefore in that liquid container 118 is substantially sealed. That is, liquid container 118 is formed of a shell 119 and an end cap 120 that is substantially airtight when secured to shell 119. This allows liquid container 118 to maintain any of a large variety of orientations without allowing the fluid (not shown) to leak out. This makes this embodiment of misting device 20 suitable for applications where the orientation of liquid container varies.

Being substantially sealed, liquid container 118 requires a means of equalizing pressure within and without the container. This is provided through a self-closing one-way valve 122. When the pressure within container 118 is less than the air pressure outside, then one-way valve 122 opens to admit air to container 118. When the pressure has been equalized, i.e., when the pressure inside container 118 is substantially equal to the pressure outside of container 118, the one-way valve 122 closes to inhibit the passage of the fluid out of container 118.

In the preferred embodiment of FIG. 13, self-closing one-way valve 122 is depicted as a cup valve formed of an elastic material and obstructing a vent 124. A decrease in pressure within container 118 causes valve 122 to deform and admit air through vent 124. When the pressure has been equalized, the elasticity of valve 122 causes valve 122 to return to its original shape and again obstruct vent 124. Those skilled in the art will appreciate that the elastic cup valve of FIG. 13 is but one of a plurality of valve types that may be used for self-closing one-way value 122. The use of other valve types for valve 122 does not depart from the spirit of the present invention.

In the preferred embodiment, vent 124 and one-way valve 122 are placed in a second end cap 126 coupled to shell 119 of container 118. This allows one-way valve 122 to operate against a flat surface. It will be appreciated that this is not a requirement of the present invention. In an alternative embodiment, shell 118 may be configured to provide a flat area anywhere desired for vent 124 and one-way valve 122. In another alternative embodiment, vent 124 may be located on a curved surface and use a one-way valve 122 configured to operate against that curved surface. The use of these and other alternative embodiments for the location and configurations of vent 124 and one-way valve 122 does not depart from the spirit of the present invention.

In FIG. 13, end caps 120 and 126 are depicted as being in smooth contact with the ends of shell 118. Those skilled in the art will appreciate that at least one of end caps 120 and 126 is desirably removably coupled to shell 119 (e.g., by screw threads (not shown), thereby permitting end cap 120 or 126 to be removed to allow the filling of container 118 with the fluid. The other of end caps 120 and 126 may be either fixedly or removably coupled to shell 119 as desired.

Portable automatic misting-device assembly 38 resides within liquid container 118. As discussed hereinbefore in connection with other embodiments, misting-device assembly 38 is formed of hollow cylinder 40, plunger 42, hollow plunger rod 28, handle 32 and resilient member (i.e., compression spring) 48. In this embodiment, plunger 42 is formed of plunger body 111 and O-ring 114 to effect a seal with cylinder 40. Those skilled in the art will appreciate that many variations are possible, and that the use of one of these variations does not depart from the spirit of the present invention.

During the pumping stroke, i.e., when handle 32 is pulled, plunger rod 28 draws plunger 42 upward, increasing the size of reservoir 50. This in turn causes a second one-way valve 128 to open. This allows fluid to be drawn through one-way valve 128, and into reservoir 50. This handle-pulling action compresses compression spring (resilient member) 48.

When handle 32 is released, compression spring 48 pushes against plunger 42 to decrease the size of reservoir 50. This in turn closes one-way valve 128. This allows fluid to be conveyed from reservoir 50, through a first fluid passage 130 in plunger 42, through a second fluid passage 132 in plunger rod 28, through a third fluid passage 134 in handle 32, and through a fourth fluid passage 136 in outlet hose 110 to misting nozzle 34 where the fluid becomes mist 36. This operation is entirely analogous to the operations of other embodiments discussed hereinbefore.

Those skilled in the art will appreciate that outlet hose 110 is not a requirement of the present invention. Misting head 34 may couple directly to handle 32 without departing from the spirit of the present invention.

In the preferred embodiment of FIG. 13, one-way valve 128 is depicted as a cup valve formed of an elastic material, i.e., as substantially identical to self-closing one-way valve 122. Those skilled in the art will appreciate that any desired valve type may be used for one-way value 128 without departing from the spirit of the present invention.

In summary, portable automatic misting assembly 38 (FIG. 2) is easy to carry and operates by using a single manual input pumping stroke to generate a relatively high hydraulic pressure which is used for automatic mist dispersion of a liquid. In one embodiment, misting assembly 38 uses remotely located liquid supply container 94 (see FIG. 7) to carry a relatively large amount of liquid to provide a relatively high quantity of desirable misting operations.

Although the preferred embodiments of the invention have been illustrated and described in detail, it will be readily apparent to those skilled in the art that various modifications may be made therein without departing from the spirit of the invention or from the scope of the appended claims.

What is claimed is:

1. A portable misting device that automatically disperses a mist, said device comprising:
a liquid container;
a first one-way valve coupled to said liquid container and configured to be substantially self closing;
a hollow cylinder coupled to said liquid container forming a liquid reservoir therein;
a plunger configured to form a substantially liquid-tight seal with an inner circumference of said cylinder;
a plunger rod having a first end proximate said reservoir and a second end opposing said first end, said first end being affixed to said plunger;
a handle affixed to said second end of said plunger rod;
a second one-way valve coupled to said cylinder and configured to permit liquid flow into said reservoir;
a resilient member coupled to said plunger and biased to automatically shrink said reservoir; and
a misting nozzle configured to produce said mist and fluidly coupled to said cylinder through said handle, said plunger rod, and said plunger.

2. A portable misting device as claimed in claim 1 wherein said resilient member is a spring coaxial with said plunger rod.

3. A portable misting device as claimed in claim 1 wherein said plunger comprises:
a body affixed to said first end of said plunger rod and having a circumferential groove; and
an O-ring coupled to said body within said circumferential groove and configured to form said substantially liquid-tight seal.

4. A portable misting device as claimed in claim 1 wherein said plunger and said plunger rod together serve to regulate a size of said reservoir.

5. A portable misting device as claimed in claim 1 wherein said resilient member is a compression spring coaxially positioned around said plunger rod and wherein:
said spring has a first end restrained at said plunger;
said spring has a second end restrained at an end of said cylinder proximate said handle;
said spring is configured such that said reservoir has a minimal size when said spring is extended; and
said spring is configured such that said reservoir has a size larger than said minimal size when said spring is compressed.

6. A portable misting device as claimed in claim 5 wherein said second one-way valve is configured to permit said liquid flow into said reservoir when said spring is being compressed and to inhibit said liquid flow into said reservoir when said compressed spring is being relaxed.

7. A portable misting device as claimed in claim 1 wherein said first one-way valve is configured to permit a passage of air into said liquid container when said spring is being compressed and to inhibit a passage of said liquid from said liquid container when said spring is not being compressed.

8. A portable misting device as claimed in claim 1 additionally comprising an outlet hose coupled between said handle and said misting nozzle.

9. A portable misting device as claimed in claim 8 wherein:
said plunger comprises a first fluid-flow passage;
said plunger rod comprises a second fluid-flow passage;
said handle comprises a thir d fluid-flow passage;
said outlet hose comprises a fourth fluid-flow passage; and
said first, second, third, and fourth fluid-flow passages together comprise a fluid conduit configured to convey said fluid from said reservoir to said misting head.

10. A portable misting device that automatically disperses a mist, said device comprising:
a liquid container;
a first one-way valve coupled to said liquid container;
a hollow cylinder coupled within said liquid container and configured to form a liquid reservoir therein;
a plunger rod having a first end contained within said cylinder proximate said reservoir and a second end outside of said liquid container;
a plunger coupled to said first end of said plunger rod and configured to form a liquid-tight seal between an inner circumference of said cylinder and said reservoir;
a handle coupled to said second end of said plunger rod;
a second one-way valve coupled to said cylinder and configured to permit liquid flow from said liquid container into said reservoir;
a resilient member coaxially positioned around said plunger rod, said resilient member being restrained on a first end at said plunger and on a second end at an end of said cylinder proximate said handle; and
a misting nozzle configured to produce said mist and fluidly coupled to said cylinder through said handle, said plunger rod, and said plunger.

11. A portable misting device as claimed in claim 10 wherein said first one-way valve is substantially self closing.

12. A portable misting device as claimed in claim 10 wherein said resilient member is configured such that when said resilient member is extended to a relatively relaxed state, said reservoir has a minimum size and when said resilient member is compressed to a relatively unrelaxed state, said reservoir size is a larger size than said minimum size.

13. A portable misting device as claimed in claim 10 wherein a size of said reservoir is increasing when said resilient member is being compressed.

14. A portable misting device as claimed in claim 13 wherein said second one-way valve is configured to permit a flow of said liquid into said reservoir when said reservoir size is increasing.

15. A portable misting device as claimed in claim 13 wherein said first one-way valve is configured to permit a passage of air into said fluid container when said reservoir size is increasing.

16. A portable misting device as claimed in claim 13 wherein said first one-way valve is configured to inhibit a passage of said fluid from said fluid container when said reservoir size is one of decreasing or static.

17. A portable misting device as claimed in claim 10 additionally comprising an outlet hose coupled between said handle and said misting nozzle.

18. A portable misting device as claimed in claim 10 wherein said resilient member is a compression spring coaxially positioned around said plunger rod.

19. A portable misting device that automatically disperses a mist, said device comprising:
a liquid container;
a first one-way valve coupled to said liquid container;
a hollow cylinder coupled within said liquid container and configured to form a liquid reservoir therein;
a plunger rod having a first end contained within said cylinder proximate said reservoir and a second end outside of said liquid container;
a plunger coupled to said first end of said plunger rod and configured to form a liquid-tight seal between an inner circumference of said cylinder and said reservoir;
a handle coupled to said second end of said plunger rod;
a second one-way valve coupled to said cylinder and configured to permit liquid flow from said liquid container into said reservoir;
a resilient member coaxially positioned around said plunger rod, said resilient member being restrained on a first end at said plunger and on a second end at an end of said cylinder proximate said handle; and
a misting nozzle configured to produce said mist and fluidly coupled to said cylinder through said handle, said plunger rod, and said plunger.

20. A portable misting device as claimed in claim 19 additionally comprising an outlet hose coupled between said handle and said misting nozzle.
